(19) United States
(12) Patent Application Publication
(10) Pub. No.: US 2020/0370620 A1
(43) Pub. Date: Nov. 26, 2020

(54) ROTARY DEVICE

(71) Applicant: EXEDY Corporation, Osaka (JP)

(72) Inventor: Yusuke TOMITA, Osaka (JP)

(73) Assignee: EXEDY Corporation

(21) Appl. No.: 16/834,598

(22) Filed: Mar. 30, 2020

(30) Foreign Application Priority Data
May 23, 2019 (JP) 2019-096543

(51) Int. Cl. F16F 15/32; F16F 15/133

(52) U.S. Cl. CPC F16F 15/32; F16F 2230/0011; F16F 2238/024; F16F 15/133

(57) ABSTRACT

A rotary device includes a first rotor, a second rotor, and an unbalanced portion. The first rotor is configured to be rotated about a rotational center. The second rotor is disposed to be concentric to the first rotor. The second rotor is rotatable relative to the first rotor within a predetermined angular range. The second rotor is radially supported with respect to the first rotor. The unbalanced portion is provided on the second rotor in order to deviate a center of gravity of the second rotor from the rotational center in a single direction.

### CROSS-REFERENCE TO RELATED APPLICATIONS

This application claims priority to Japanese Patent Application No. 2019-096543, filed May 23, 2019. The contents of that application are incorporated by reference herein in their entirety.

### TECHNICAL FIELD

The present invention relates to a rotary device including two rotors that are rotatable relative to each other.

### BACKGROUND ART

For example, a clutch device, including a damper device, and a torque converter are provided between an engine and a transmission in an automobile. For reduction in fuel consumption, the torque converter is provided with a lock-up device for mechanically transmitting a torque at a predetermined rotational speed or greater.

Japan Laid-open Patent Application Publication No. 2017-053467 describes a lock-up device including a torque fluctuation inhibiting device. The torque fluctuation inhibiting device described in Japan Laid-open Patent Application Publication No. 2017-053467 includes a hub flange, an inertia ring, a plurality of centrifugal elements and a plurality of cam mechanisms. The hub flange and the inertia ring are two rotors that are rotatable relative to each other. Each centrifugal element receives a centrifugal force generated by rotation of the hub flange and the inertia ring. Each cam mechanism includes a cam provided on the surface of each centrifugal element and a cam follower making contact with the cam.

In the device described in Japan Laid-open Patent Application Publication No. 2017-053467, when the hub flange and the inertia ring are displaced in a rotational direction by torque fluctuations, each cam mechanism is actuated in response to the centrifugal force acting on each centrifugal element, and converts the centrifugal force acting on each centrifugal element into a circumferential force directed to reduce the displacement between the hub flange and the inertia ring. Torque fluctuations are inhibited by this circumferential force.

In the torque fluctuation inhibiting device described in Japan Laid-open Patent Application Publication No. 2017-053467, the inertia ring is supported by the hub flange through the plural centrifugal elements. In such a structure, there likely occurs displacement in radial position (displacement in axis) of the inertia ring with respect to the hub flange. This results in increase in amount of rotational imbalance in entirety of the device. The amount of rotational imbalance works as a factor bringing about vibration of the body of a vehicle in which the torque fluctuation inhibiting device is installed.

Displacement in axis of the inertia ring is attributed to the amount of rotational imbalance of the inertia ring per se and so forth. However, in general, displacement in axis of the inertia ring, attributed to the amount of rotational imbalance, is not caused in a definite direction. Because of this, the rotational imbalance in entirety of the torque fluctuation inhibiting device occurs in irregular directions. As a result, this makes it difficult to reduce vibration of the body of the vehicle in which the torque fluctuation inhibiting device is installed.

Such a problem is not limited to the torque fluctuation inhibiting device described in Japan Laid-open Patent Application Publication No. 2017-053467, and could occur in such a device that two rotors are disposed to be rotatable relative to each other while one of the rotors is radially supported by the other.

### BRIEF SUMMARY

It is an object of the present invention to configure a device, including two rotors disposed to be rotatable relative to each other, to cause rotational imbalance in a definite direction in order to enable reduction in amount of rotational imbalance in entirety of an apparatus in which the device is installed.

(1) A rotary device according to the present invention includes a first rotor, a second rotor and an unbalanced portion. The first rotor is rotated about a rotational center. The second rotor is disposed to be concentric to the first rotor. The second rotor is rotatable relative to the first rotor within a predetermined angular range and is radially supported with respect to the first rotor. The unbalanced portion is provided on the second rotor in order to deviate a center of gravity of the second rotor from the rotational center in a single direction.

In the present rotary device, the second rotor is provided with the unbalanced portion on purpose. Hence, the second rotor is rotated while the axis thereof deviates from that of the first rotor always in the same direction. In other words, this results in occurrence of stable rotational imbalance. Therefore, the rotational imbalance attributed to the unbalanced portion can be easily canceled out by providing a balance modifying portion on either the first rotor or another rotary member in an apparatus in which the present rotary device is installed, whereby the amount of imbalance in entirety of the apparatus can be reduced.

(2) Preferably, the first rotor and the second rotor are disc-shaped plate members.

(3) Preferably, the unbalanced portion is at least one cutout provided on an outer peripheral end of the second rotor. The at least one cutout is opened radially outward and is recessed radially inward at a predetermined depth. The unbalanced portion can be herein realized with a simple configuration.

(4) Preferably, the unbalanced portion is at least one bulge provided to protrude radially outward from an outer peripheral surface of the second rotor. Similarly to the above, the unbalanced portion can be herein realized with a simple configuration.

(5) Preferably, the unbalanced portion is at least one bulge provided to protrude radially outward from an outer peripheral surface of the second rotor. Besides preferably, the bulge is disposed in opposition to the cutout through the rotational center.

(6) Preferably, the unbalanced portion is a thickness changed portion provided on the second rotor. The thickness changed portion is different in thickness from the other part of the second rotor.

(7) Preferably, the first rotor includes a first contact portion disposed in annular alignment. The first contact portion includes a first contact surface on an outer or inner peripheral surface thereof. Besides, in this case, the second rotor preferably includes a second contact portion disposed in annular alignment. The second contact portion includes a second contact surface on an inner or outer peripheral surface thereof in order to radially position the second rotor with respect to the first rotor. The second contact surface is capable of making contact with the first contact surface.

(8) Preferably, the rotary device further includes a balance modifying portion. The balance modifying portion is provided on the first rotor and is disposed in opposition to the unbalanced portion through the rotational center.

The amount of imbalance in entirety of the present rotary device can be herein reduced by the unbalanced portion and the balance modifying portion.

(9) Preferably, the rotary device further includes a third rotor and a balance modifying portion. The third rotor is disposed to be concentric to the first rotor and the second rotor and is rotated together with the first rotor and the second rotor. The balance modifying portion is provided on the third rotor and is disposed in opposition to the unbalanced portion through the rotational center.

It is herein possible to reduce the amount of imbalance in entirety of the apparatus, in which the present rotary device is installed, by the unbalanced portion and the balance modifying portion.

(10) Preferably, the first rotor is an input rotor to which power is inputted, and the second rotor is an inertia ring rotatable relative to the input rotor. Besides, the rotary device further includes a plurality of centrifugal elements and a plurality of cam mechanisms. Each of the plurality of centrifugal elements is disposed to receive a centrifugal force generated by rotation of the first rotor and the inertia ring. When a relative displacement is produced between the rotor and the inertia ring in a rotational direction while the centrifugal force is acting on the each of the plurality of centrifugal elements, each of the plurality of cam mechanisms converts the centrifugal force into a circumferential force directed to reduce the relative displacement.

In the present rotary device, when a torque is inputted to the input rotor, the input rotor and the inertia ring are rotated. When the torque inputted to the input rotor does not fluctuate, any relative displacement is not produced between the input rotor and the inertia ring in the rotational direction. Therefore, the input rotor and the inertia ring are rotated in synchronization with each other. On the other hand, when the torque inputted to the input rotor fluctuates, the relative displacement is produced between the input rotor and the inertia ring in the rotational direction depending on the extent of torque fluctuations, because the inertia ring is disposed to be rotatable relative to the input rotor.

When the input rotor and the inertia ring are herein rotated, a centrifugal force acts on each centrifugal element. Then, when the relative displacement is produced between the input rotor and the inertia ring, each cam mechanism converts the centrifugal force acting on each centrifugal element into a circumferential force, and the circumferential force acts to reduce the relative displacement between the input rotor and the inertia ring. Torque fluctuations are inhibited by the herein described actuation of each cam mechanism.

Overall, according to the present invention described above, rotational imbalance occurs in a definite direction in a rotary device including two rotors disposed to be rotatable relative to each other. Because of this, it is enabled to easily reduce the amount of rotational imbalance in entirety of an apparatus in which the rotary device is installed.

### BRIEF DESCRIPTION OF THE DRAWINGS

FIG. 1 is a schematic diagram of a torque converter according to a first preferred embodiment of the present invention.

FIG. 2 is a partial front view of a hub flange and a torque fluctuation inhibiting device that are shown in FIG. 1.

FIG. 3 is a view of FIG. 2 as seen from arrow A.

FIG. 4 is a cross-sectional view of FIG. 2 taken along line IV-IV.

FIG. 5 is a front view of an inertia ring.

FIG. 6 is a diagram for explaining actuation of each cam mechanism.

FIG. 7 is a cross-sectional view of an inertia ring according to a second preferred embodiment of the present invention.

FIG. 8 is a cross-sectional view of an inertia ring according to a third preferred embodiment of the present invention.

### DETAILED DESCRIPTION

### First Preferred Embodiment

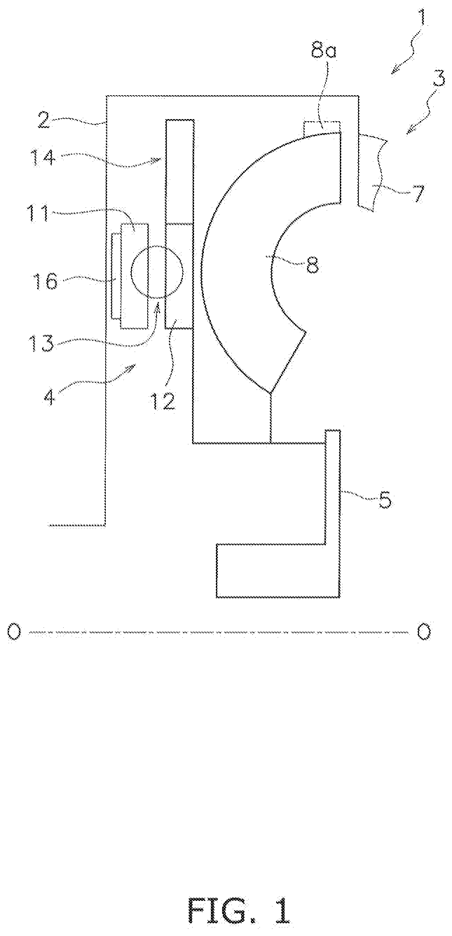

A torque fluctuation inhibiting device will be herein explained as an example of a rotary device. FIG. 1 is a schematic diagram of a condition that a torque fluctuation inhibiting device according to a first exemplary embodiment of the present invention is attached to a lock-up device for a torque converter. In FIG. 1, line O-O indicates a rotational center for both the torque converter and the torque fluctuation inhibiting device.

### [Entire Configuration]

A torque converter 1 includes a front cover 2, a torque converter body 3, a lock-up device 4 and an output hub 5. A torque is inputted to the front cover 2 from an engine. The torque converter body 3 includes an impeller 7 coupled to the front cover 2, a turbine 8 and a stator (not shown in the drawings). The turbine 8 is coupled to the output hub 5. An input shaft of a transmission (not shown in the drawings) is capable of being spline-coupled to the inner peripheral part of the output hub 5.

### [Lock-Up Device 4]

The lock-up device 4 includes a clutch part, a piston to be actuated by hydraulic pressure, and so forth, and can be set to a lock-up on state and a lock-up off state. In the lock-up on state, the torque inputted to the front cover 2 is transmitted to the output hub 5 through the lock-up device 4 without through the torque converter body 3. On the other hand, in the lock-up off state, the torque inputted to the front cover 2 is transmitted to the output hub 5 through the torque converter body 3.

The lock-up device 4 includes an input-side rotor 11, a hub flange 12 (exemplary first rotor), a damper 13 and a torque fluctuation inhibiting device 14 including the hub flange 12.

The input-side rotor 11 includes the piston axially movable and is provided with a friction member 16 fixed to the front cover 2-side lateral surface thereof. When the friction member 16 is pressed onto the front cover 2, the torque is transmitted from the front cover 2 to the input-side rotor 11.

The hub flange 12 is disposed in axial opposition to the input-side rotor 11 and is rotatable relative to the input-side rotor 11. The hub flange 12 is coupled to the output hub 5.

The damper 13 is disposed between the input-side rotor 11 and the hub flange 12. The damper 13 includes a plurality of torsion springs and elastically couples the input-side rotor 11 and the hub flange 12 in a rotational direction. The damper 13 transmits the torque from the input-side rotor 11 to the hub flange 12 and also absorbs and attenuates torque fluctuations.

### [Torque Fluctuation Inhibiting Device 14]

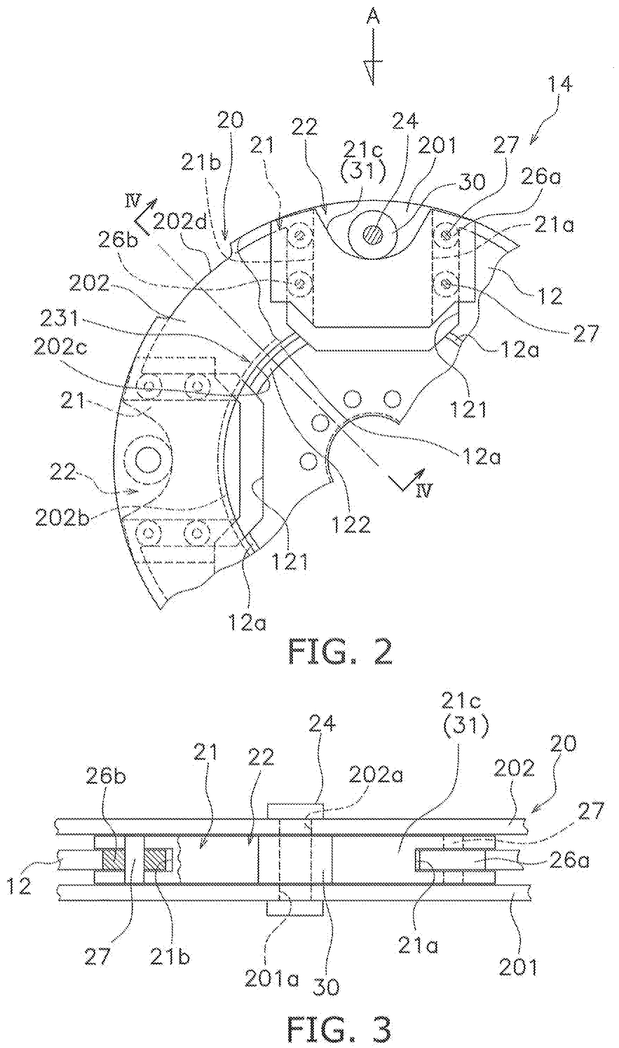

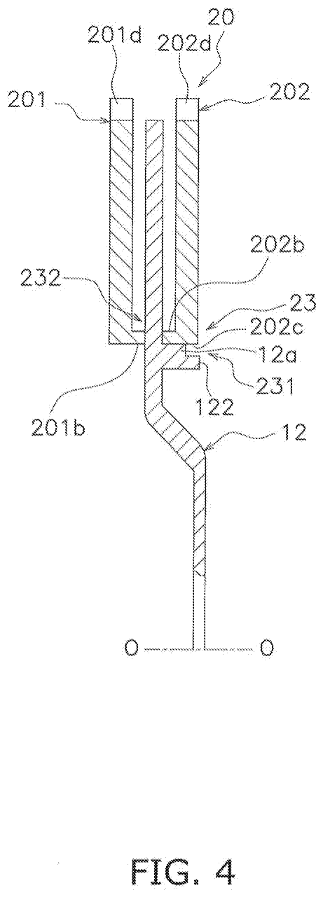

FIG. 2 is a front view of the torque fluctuation inhibiting device 14 including the hub flange 12. It should be noted that FIG. 2 in part shows a condition that one of inertia rings (near-side inertia ring) is detached. FIG. 3 is a view of FIG. 2 as seen from arrow A, whereas FIG. 4 is a cross-sectional view of FIG. 2 taken along line IV-IV.

The torque fluctuation inhibiting device 14 includes first and second inertia rings 201 and 202 (exemplary second rotor) composing a mass body 20, four centrifugal elements 21, four cam mechanisms 22 and a positioning mechanism 23.

### <First and Second Inertia Rings 201 and 202>

Each of the first and second inertia rings 201 and 202 is a continuous annular plate having a predetermined thickness. As shown in FIG. 3, the first and second inertia rings 201 and 202 are disposed axially on the both sides of the hub flange 12 such that a predetermined gap is produced between the hub flange 12 and each inertia ring 201, 202. In other words, the hub flange 12 and the first and second inertia rings 201 and 202 are disposed in axial alignment. The first and second inertia rings 201 and 202 have a common rotational center that is the same as the rotational center of the hub flange 12. The first and second inertia rings 201 and 202 are rotatable with the hub flange 12 and are also rotatable relative to the hub flange 12 within a predetermined angular range.

Each of the first and second inertia rings 201 and 202 includes four holes 201a, 202a, each of which axially penetrates therethrough. Besides, the first and second inertia rings 201 and 202 are fixed by rivets 24 that penetrate the holes 201a and 202a thereof. Therefore, the first inertia ring 201 is axially, radially and rotation-directionally immovable with respect to the second inertia ring 202.

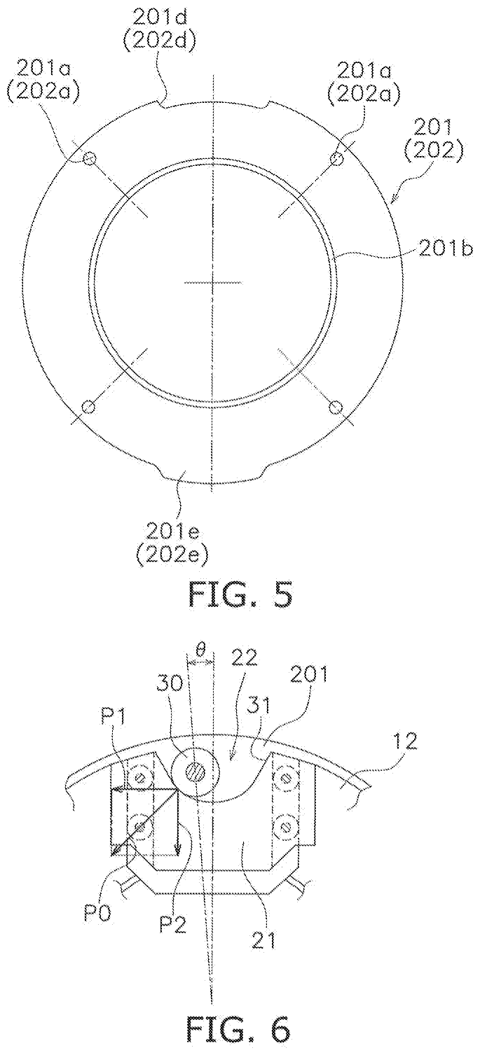

Furthermore, as shown in FIGS. 4 and 5, each of the first and second inertia rings 201 and 202 includes a protrusion 201b, 202b having an annular shape, an unbalanced portion 201d, 202d, and an unbalanced portion 201e, 202e. Configurations of these elements will be described below

### <Hub Flange 12>

The hub flange 12 has a disc shape, and as described above, is coupled at the inner peripheral part thereof to the output hub 5. The hub flange 12 is provided with four recesses 121 on the outer peripheral part thereof. The recesses 121 are disposed at angular intervals of 90 degrees in the circumferential direction. Each recess 121 is opened to the outer peripheral side and has a predetermined depth. Besides, each recess 121 has a predetermined width in the circumferential direction. As described below, the hub flange 12 further includes a balance modifying portion 122.

### <Centrifugal Elements 21>

The centrifugal elements 21 are disposed in the recesses 121 of the hub flange 12, respectively, and are radially movable by centrifugal forces to be generated by rotation of the hub flange 12. Each centrifugal element 21 has a circumferentially extending shape and includes grooves 21a and 21b on the both circumferential ends thereof. Each groove 21a, 21b has a width greater than the thickness of the hub flange 12, and the hub flange 12 is inserted into part of each groove 21a, 21b.

It should be noted that an outer peripheral surface 21c of each centrifugal element 21 dents in a circular-arc shape to the inner peripheral side, and as described below, functions as a cam 31.

Two rollers 26a and two rollers 26b are disposed in the grooves 21a and 21b provided on the both ends of each centrifugal element 21, respectively. The respective rollers 26a and 26b are rotatably attached about pins 27 provided to penetrate the grooves 21a and 21b in a rotational axis direction. Besides, the respective rollers 26a and 26b are capable of rolling along and in contact with the lateral surfaces of each recess 121.

### <Cam Mechanisms 22>

Each cam mechanism 22 is composed of a roller 30 and the cam 31. The roller 30 is provided as a cam follower and has a cylindrical shape. The cam 31 corresponds to the outer peripheral surface 21c of each centrifugal element 21. The roller 30 is fitted to the outer periphery of the trunk of each rivet 24. In other words, the roller 30 is supported by each rivet 24. It should be noted that the roller 30 is preferably attached to each rivet 24 in a rotatable manner, but alternatively, can be attached to each rivet 24 in a non-rotatable manner. The cam 31 is a circular-arc surface with which the roller 30 makes contact. The roller 30 is moved along the cam 31 when the hub flange 12 and the first and second inertia rings 201 and 202 are rotated relative to each other in a predetermined angular range.

Although described below in detail, when torsion (phase difference in the rotational direction) is produced between the hub flange 12 and the first and second inertia rings 201 and 202 by the contact between the roller 30 and the cam 31, a centrifugal force generated in each centrifugal element 21 is converted into a circumferential force by which the rotational phase difference is reduced.

### <Positioning Mechanism 23>

As shown in FIG. 4, the positioning mechanism 23 includes a radial positioning mechanism 231 and an axial positioning mechanism 232. The radial positioning mechanism 231 radially positions the first and second inertia rings 201 and 202 with respect to the hub flange 12. The axial positioning mechanism 232 axially positions the first and second inertia rings 201 and 202 with respect to the hub flange 12.

As shown in FIGS. 2 and 4, the radial positioning mechanism 231 is composed of four protrusions 12a (exemplary first contact portion) provided on the hub flange 12 and an inner peripheral surface 202c (exemplary second contact portion) of the protrusion 202b of the second inertia ring 202.

In more detail, the four protrusions 12a are disposed at angular intervals of 90 degrees in the circumferential direction. Besides, each protrusion 12a is provided to axially protrude from a radially intermediate part of the second inertia ring 202-side lateral surface of the hub flange 12. The inner peripheral surface 202c of the protrusion 202b of the second inertia ring 202 makes contact with the outer peripheral surface of each protrusion 12a, whereby the second inertia ring 202 and the first inertia ring 201 fixed thereto are radially positioned with respect to the hub flange 12.

The axial positioning mechanism 232 is composed of the both lateral surfaces of the hub flange 12 and the protrusions 201b and 202b of the first and second inertia rings 201 and 202. In more detail, the first and second inertia rings 201 and 202 are provided with the protrusions 201b and 202b axially protruding from the inner peripheral ends thereof, respectively. The protrusions 201b and 202b are capable of making contact at the distal ends thereof with the both lateral surfaces of the hub flange 12, respectively. Therefore, the protrusions 201b and 202b make contact at the distal ends thereof with the hub flange 12, whereby the first and second inertia rings 201 and 202 are restricted from axially moving. In other words, the first and second inertia rings 201 and 202 are axially positioned with respect to the hub flange 12.

As described above, the protrusion 202b of the second inertia ring 202 composes part of the radial positioning mechanism 231 and composes part of the axial positioning mechanism 232 as well. Because of this, with a simple configuration, the first and second inertia rings 201 and 202 can be radially and axially positioned with respect to the hub flange 12.

### <Unbalanced Portion and Balance Modifying Portion>

As shown in FIGS. 4 and 5, each of the first and second inertia rings 201 and 202 is provided with a cutout 201d, 202d and a bulge 201e, 202e, both of which compose the unbalanced portion. The cutout 201d, 202d is provided circumferentially between adjacent two of the holes 201a, 202a. The cutout 201d, 202d has a predetermined width in the circumferential direction and is recessed radially inward with a predetermined depth while opened radially outward. On the other hand, the bulge 201e, 202e is disposed in a position opposed to the cutout 201d, 202d through the rotational center. The bulge 201e, 202e is provided to protrude radially outward and has a circumferential width approximately equal to that of the cutout 201d, 202d.

Each of the first and second inertia rings 201 and 202 includes the unbalanced portion 201d, 202d and the unbalanced portion 201e, 202e as described above, whereby the center of gravity of each inertia ring 201, 202 deviates from the rotational center to a side on which the bulge 201e, 202e is provided. Because of this, during rotation, the axis of each inertia ring 201, 202 is configured to be displaced from that of the hub flange 12 always in the same direction.

For example, in assumption of each inertia ring 201, 202 having a diameter of 200 to 300 mm, the amount of rotational imbalance intended by the unbalanced portion 201d, 202d and the unbalanced portion 201e, 202e is preferably set to fall in a range of 100 to 1000 g. mm. It should be noted that in a well-known inertia ring having a diameter of 200 to 300 mm, the amount of rotational imbalance is generally set to about 0 to 100 g·mm.

On the other hand, the hub flange 12 is provided with the balance modifying portion 122. As shown in FIGS. 2 and 4, the balance modifying portion 122 is provided on the inner peripheral part of one of the four protrusions 12a. This protrusion 12a is provided in a position opposed to the bulge 201e, 202e of each inertia ring 201, 202 through the rotational center. Thus, this protrusion 12a is provided with the balance modifying portion 122 on the inner peripheral part thereof.

The balance modifying portion 122 has a length approximately equal to that of the protrusion 12a in the circumferential direction and has a predetermined thickness in the radial direction. Rotational imbalance, attributed to the unbalanced portion 201d, 202d and the unbalanced portion 201e, 202e, is modified by the balance modifying portion 122, whereby rotational imbalance in entirety of the torque fluctuation inhibiting device 14 is suppressed to a low level.

### <Actuation of Cam Mechanisms 22>

Actuation of each cam mechanism 22 (inhibition of torque fluctuations) will be explained with FIGS. 2 and 6. It should be noted that in the following explanation, the pair of first and second inertia rings 201 and 202 will be simply referred to as “an inertia ring 20” on an as-needed basis.

In the lock-up on state, a torque transmitted to the front cover 2 is transmitted to the hub flange 12 through the input-side rotor 11 and the damper 13.

When torque fluctuations do not exist in torque transmission, the hub flange 12 and the inertia ring 20 are rotated in the condition shown in FIG. 2. In this condition, the roller 30 in each cam mechanism 22 is contacted to the most inner peripheral position (circumferential middle position) of the cam 31, and the rotational phase difference between the hub flange 12 and the inertia ring 20 is “0”.

As described above, the rotation-directional relative displacement between the hub flange 12 and the inertia ring 20 is referred to as “rotational phase difference”. In FIGS. 2 and 6, these terms indicate displacement between the circumferential middle position of each centrifugal element 21 and each cam 31 and the center position of each roller 30.

When torque fluctuations herein exist in torque transmission, rotational phase difference θ is produced between the hub flange 12 and the inertia ring 20 as shown in FIG. 6.

As shown in FIG. 6, when the rotational phase difference θ is produced between the hub flange 12 and the inertia ring 20, the roller 30 in each cam mechanism 22 is relatively moved along the cam 31 to the left side in FIG. 6. At this time, a centrifugal force acts on each centrifugal element 21. Hence, a reaction force to be received by the cam 31 provided on each centrifugal element 21 from the roller 30 has a direction and a magnitude indicated by P0 in FIG. 6. A first force component P1 and a second force component P2 are produced by the reaction force P0. The first force component P1 is directed in the circumferential direction, whereas the second force component P2 is directed to move each centrifugal element 21 to the inner peripheral side.

Additionally, the first force component P1 acts as a force to move the hub flange 12 leftward in FIG. 6 through each cam mechanism 22 and each centrifugal element 21. In other words, a force directed to reduce the rotational phase difference between the hub flange 12 and the inertia ring 20 is supposed to act on the hub flange 12. On the other hand, the second force component P2 moves each centrifugal element 21 to the inner peripheral side against the centrifugal force.

It should be noted that when the rotational phase difference is reversely produced, the roller 30 is relatively moved along the cam 31 to the right side in FIG. 6. However, the aforementioned actuation principle is also true of this case.

As described above, when the rotational phase difference is produced between the hub flange 12 and the inertia ring 20 by torque fluctuations, the hub flange 12 receives a force (first force component P1) directed to reduce the rotational phase difference between the both by the centrifugal force acting on each centrifugal element 21 and the working of each cam mechanism 22. Torque fluctuations are inhibited by this force.

The aforementioned force inhibiting torque fluctuations varies in accordance with the centrifugal force, in other words, the rotational speed of the hub flange 12, and also varies in accordance with the rotational phase difference and the shape of each cam 31. Therefore, by suitably setting the shape of each cam 31, characteristics of the torque fluctuation inhibiting device 14 can be made optimal in accordance with the specification of the engine and so forth.

For example, each cam 31 can be made in a shape that makes the first force component P1 linearly vary in accordance with the rotational phase difference in a condition where the centrifugal force acting is constant. Alternatively, each cam 31 can be made in a shape that makes the first force component P1 non-linearly vary in accordance with the rotational phase difference.

Each first or second inertia ring 201, 202 is provided with the unbalanced portion 201d, 202d and the unbalanced portion 201e, 202e. Hence, during actuation of the cam mechanisms 22 configured as described above, the axis of each first or second ring 201, 202 deviates from that of the hub flange 12 always in the same direction while in rotation. In other words, rotational imbalance is made regular, whereby reduction in rotational imbalance in entirety of the torque fluctuation inhibiting device 14 is made easy by the balance modifying portion 122 provided on the hub flange 12. Therefore, it is possible to reduce vibration of the body of the vehicle in which the torque fluctuation inhibiting device 14 is installed.

Besides, due to a similar reason to the above, the protrusions 12a and the protrusion 202b of the second inertia ring 202 are inhibited from making contact with each other with a strong force in the radial positioning mechanism 231.

Moreover, axial movement of the first and second inertia rings 201 and 202 is also restricted by the axial positioning mechanism 232. Therefore, each of the first and second inertia rings 201 and 202 can be prevented from making contact with the lateral surface of each centrifugal element 21 with a strong force. This enables each centrifugal element 21 to be actuated always smoothly, whereby stable torque fluctuation inhibiting characteristics can be obtained.

### Second Preferred Embodiment

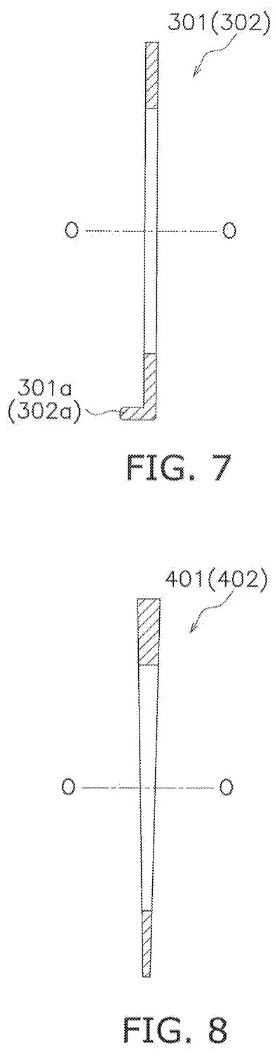

FIG. 7 shows an inertia ring 301, 302 of a torque fluctuation inhibiting device according to a second preferred embodiment of the present invention. In the second preferred embodiment, the inertia ring 301, 302 includes a bent portion 301a, 302a, which is axially bent, on part of the outer peripheral end thereof. The bent portion 301a, 302a functions as an unbalanced portion. With the configuration herein described, the center of gravity of the inertia ring 301, 302 deviates from the rotational center to a side on which the bent portion 301a, 302a is provided. Advantageous effects similar to those achieved in the first preferred embodiment can be achieved as well in the second preferred embodiment herein described.

### Third Preferred Embodiment

FIG. 8 shows an inertia ring 401, 402 of a torque fluctuation inhibiting device according to a third preferred embodiment of the present invention. In the third preferred embodiment, the inertia ring 401, 402 is produced by utilizing difference in thickness within a sheet of roll material. Here, difference in thickness within the sheet of roll material functions as an unbalanced portion.

Specifically, in general, the sheet of coil material varies in thickness depending on parts thereof. For example, when the sheet of coil material is thick in a width directional middle part thereof, two inertia rings can be manufactured by punching the sheet of coil material in the width direction. In this case, each inertia ring includes the middle part of the sheet of coil material as part of the outer periphery thereof. Because of this, part of the outer periphery is heavier than the other part. This means that the center of gravity of each inertia ring 401, 402 deviates from the rotational center to a side on which such a thick part is provided. Advantageous effects similar to those achieved in the first preferred embodiment can be achieved as well in the third preferred embodiment herein described.

### Other Preferred Embodiments

The present invention is not limited to the preferred embodiments described above, and a variety of changes or modifications can be made without departing from the scope of the present invention.

(a) The configuration of the unbalanced portion is not limited to that in each of the aforementioned preferred embodiments. For example, in the first preferred embodiment, only either of the cutout and the bulge can be provided. Alternatively, the unbalanced portion can be realized by, for instance, fixing a weight provided as a separate member to each inertia ring or forming a hole in each inertia ring.

(b) In the aforementioned preferred embodiments, the balance modifying portion is provided on the hub flange. However, as depicted with dashed two-dotted line in FIG. 1, a balance modifying portion 8a can be provided on the turbine 8 (exemplary third rotor) of the torque converter 1 to which the torque fluctuation inhibiting device 14 is attached.

(c) In the aforementioned preferred embodiments, the present invention has been applied to the torque fluctuation inhibiting device. However, the present invention is similarly applicable to another type of rotary device.

### REFERENCE SIGNS LIST

8 Turbine (third rotor)
8a Balance modifying portion
12 Hub flange (first rotor)
12a Protrusion (first contact portion)
21 Centrifugal element
22 Cam mechanism
122 Balance modifying portion
201, 202 Inertia ring (second rotor)
202c Inner peripheral surface (second contact portion)
201d, 202d Cutout (unbalanced portion)
201e, 202e Bulge (unbalanced portion)

What is claimed is:

1. A rotary device comprising:
a first rotor configured to be rotated about a rotational center;
a second rotor disposed to be concentric to the first rotor, the second rotor rotatable relative to the first rotor within a predetermined angular range, the second rotor radially supported with respect to the first rotor; and
an unbalanced portion provided on the second rotor in order to deviate a center of gravity of the second rotor from the rotational center in a single direction.

2. The rotary device according to claim 1, wherein the first rotor and the second rotor are disc-shaped plate members.

3. The rotary device according to claim 2, wherein the unbalanced portion is at least one cutout provided on an outer peripheral end of the second rotor, the at least one cutout opened radially outward, the at least one cutout recessed radially inward at a predetermined depth.

4. The rotary device according to claim 2, wherein the unbalanced portion is at least one bulge provided to protrude radially outward from an outer peripheral surface of the second rotor.

5. The rotary device according to claim 3, wherein the unbalanced portion is at least one bulge provided to protrude radially outward from an outer peripheral surface of the second rotor, the bulge opposed to the cutout through the rotational center.

6. The rotary device according to claim 1, wherein the unbalanced portion is a thickness changed portion provided on the second rotor, the thickness changed portion is different in thickness from the other part of the second rotor.

7. The rotary device according to claim 1, wherein
the first rotor includes a first contact portion disposed in annular alignment, the first contact portion including a first contact surface on an outer or inner peripheral surface thereof, and
the second rotor includes a second contact portion disposed in annular alignment, the second contact portion including a second contact surface on an inner or outer peripheral surface thereof in order to radially position the second rotor with respect to the first rotor, the second contact surface configured to make contact with the first contact surface.

8. The rotary device according to claim 1, further comprising:
a balance modifying portion provided on the first rotor, the balance modifying portion opposed to the unbalanced portion through the rotational center.

9. The rotary device according to claim 1, further comprising:
a third rotor disposed to be concentric to the first rotor and the second rotor, the third rotor configured to be rotated together with the first rotor and the second rotor; and
a balance modifying portion provided on the third rotor, the balance modifying portion opposed to the unbalanced portion through the rotational center.

10. The rotary device according to claim 1, wherein
the first rotor is an input rotor to which power is inputted, and
the second rotor is an inertia ring rotatable relative to the input rotor, the rotary device further comprising:
a plurality of centrifugal elements, each of the plurality of centrifugal elements disposed to receive a centrifugal force generated by rotation of the first rotor and the inertia ring; and
a plurality of cam mechanisms, each of the plurality of cam mechanisms configured to convert the centrifugal force into a circumferential force when a relative displacement is produced between the rotor and the inertia ring in a rotational direction while the centrifugal force is acting on the each of the plurality of centrifugal elements, the circumferential force directed to reduce the relative displacement.
